(19) United States
(12) Patent Application Publication
(10) Pub. No.: US 2015/0288914 A1
(43) Pub. Date: Oct. 8, 2015

(54) Apparatus for Electronic Presentation of Time-Varying Digital Imagery With or Without Accompanying Audio Under a Transparent or Translucent Form in Response to Sensor Data

(71) Applicants: Scott Lester Minneman, San Francisco, CA (US); June Delight Beltran, San Francisco, CA (US)

(72) Inventors: Scott Lester Minneman, San Francisco, CA (US); June Delight Beltran, San Francisco, CA (US)

(21) Appl. No.: 14/246,027

(22) Filed: Apr. 4, 2014

(51) Int. Cl. H04N 5/63; H04N 5/64; H04N 5/645; G09F 19/02

(52) U.S. Cl. CPC H04N 5/63; G09F 19/02; H04N 5/642; H04N 5/645

(57) ABSTRACT

A crystal ball or globe display system (10) comprises a support base assembly (14), and globe assembly (12). Circuitry (20) is housed within the support base assembly (14). The globe assembly (12) comprises a transparent enclosure (13) adhered to a transparent disc (11) which surrounds and is mounted to the top of a video display (16). The transparent enclosure (13) and transparent disc (11) defines a space of a solid transparent form or form filled with a fluid, wherein the video display (16) is viewed through the transparent form or fluid-filled space (which may include optional particulates). The globe display system (10) further comprises circuitry (20) that includes a video controller (17A), video/audio storage (17B), the video display (16), a motion sensor (18A), a power conditioner (18B), a battery charger (18C), a rechargeable battery (19), and an optional audio transducer (24), housed in the support base assembly (14). The video display (16) is motion and position sensitive, activated in response to physical motion applied to the globe display system (10). The crystal ball or globe display system (10), in the form of a handheld or table-mounted sphere, is shaken or otherwise excited to activate the video, with or without accompanying audio emitted from an internal audio speaker (24) housed within the support base assembly (14).

### CROSS-REFERENCE TO RELATED APPLICATION

The application is commonly assigned and related to Provisional Application No. 61/808,231 entitled “APPARATUS FOR ELECTRONIC DISPLAY OF TIME-VARYING DIGITAL IMAGERY UNDER A VESSEL OF TRANSPARENT AND/OR PARTICULATE-LOADED FLUID IN RESPONSE TO PHYSICAL MOTION, by the present inventor, Scott L. Minneman, filed Apr. 4, 2013, the entirety of which is incorporated herein by reference. This application claims priority on the aforementioned related provisional application.

### BACKGROUND

### Prior Art

The following is a tabulation of some prior art that presently appears relevant:

| Cited | | Publication | | |
|---|---|---|---|---|
| Patent | Filing date | date | Applicant | Title |
| U.S. Pat. No. 3,798,833 | Feb. 8, 1973 | Mar. 26, 1974 | Baltimore | Talking toy |
| | | | Brushes Inc | |
| U.S. Pat. No. 4,765,823 | Feb. 12, 1988 | Aug. 23, 1988 | Cardillo Gary J | Talking crystal |
| | | | | ball toy |
| U.S. Pat. No. 4,961,276 | Jun. 14, 1988 | Oct. 9, 1990 | Lin Ming H | Ornamental |
| | | | | crystal ball |
| U.S. Pat. No. 5,482,277 | Jun. 22, 1994 | Jan. 9, 1996 | Young; Gordon | Method of |
| | | | | operating a |
| | | | | talking crystal ball |
| | | | | toy |
| U.S. Pat. No. 5,732,492 | Sep. 18, 1996 | Mar. 31, 1998 | Lin; Chung-Kuei | Crystal water ball |
| | | | | device |
| U.S. Pat. No. 5,864,976 | Aug. 6, 1997 | Feb. 2, 1999 | Ya Yung | Driving |
| | | | Enterprise Co., | mechanism of |
| | | | Ltd. | video snow drop |
| | | | | ball |
| U.S. Pat. No. 6,161,317 | Sep. 13, 1999 | Dec. 19, 2000 | Chih Chuag | Decorative |
| | | | X'mas | amusement |
| | | | Decoration | device |
| | | | Factory | |
| U.S. Pat. No. 6,722,064 * | Apr. 17, 2002 | Apr. 20, 2004 | Albert F. | Active display |
| | | | Knapp | device |
| U.S. Pat. No. 6,722,064 * | Apr. 17, 2002 | Apr. 20, 2004 | Albert F. | Active display |
| | | | Knapp | device |
| U.S. Pat. No. 7,040,950 * | Jun. 16, 2004 | May 9, 2006 | Ching-Chao | Thermal energy- |
| | | | Chen | actuated toy |
| | | | | water globe |
| U.S. Pat. No. 7,056,006 * | Nov. 24, 2003 | Jun. 6, 2006 | Sws | Nightlight with |
| | | | Development, | interchangeable |
| | | | L.L.C. | rotating design |
| | | | | disk |
| U.S. Pat. No. 7,065,908 * | Aug. 27, 2002 | Jun. 27, 2006 | Juan Ramon | Snow globe |
| | | | Pineda- | assembly |
| | | | Sanchez | |
| U.S. Pat. No. 7,222,988 * | Sep. 21, 2004 | May 29, 2007 | Gober David | Display device |
| | | | A | for illuminating |
| | | | | optical storage |
| | | | | disks for visual |
| | | | | display and |
| | | | | method of using |
| | | | | the same |
| U.S. Pat. No. 7,395,624 * | Mar. 21, 2006 | Jul. 8, 2008 | Murrell Jon F | Diorama ball with |
| | | | | imitation fog |
| U.S. Pat. No. 7,726,830 * | Sep. 26, 2008 | Jun. 1, 2010 | Chin-Sheng | Structure of fiber |
| | | | Yang | optics |
| | | | | decoration |
| U.S. Pat. No. 7,905,426 | May 14, 2008 | Mar. 15, 2011 | For Your | Fragrance |
| | | | Ease Only, | emitting snow |
| | | | Inc. | globe |
| U.S. Pat. No. 8,393,099 * | Nov. 14, 2011 | Mar. 12, 2013 | Rainglobes | Device for |
| | | | LLC | creating and |
| | | | | displaying liquid- |
| | | | | medium |
| | | | | movement within |
| | | | | a vessel |
| | | | | containing a |
| | | | | dioramic scene |
| U.S. Pat. No. 8,446,367 | Apr. 17, 2009 | May 21, 2013 | Microsoft | Camera-based |
| U.S. Pat. No. 6,722,064 * | Apr. 17, 2002 | Apr. 20, 2004 | Albert F. | Active display |
| | | | Knapp | device |
| | | | Corporation | multi-motion |
| | | | | mouse |
| US20100149094 * | Oct. 26, 2009 | Jun. 17, 2010 | Steve Barnes | Snow Globe |
| | | | | Interface for |
| | | | | Electronic |
| | | | | Weather Report |
| US20110275491 * | Jul. 15, 2011 | Nov. 10, 2011 | Mark W. | Hopping ball |
| | | | Publicover | |
| US20120055054 * | Nov. 14, 2011 | Mar. 8, 2012 | Rain Globes | Device for |
| | | | Llc | creating and |
| | | | | displaying liquid- |
| | | | | medium |
| | | | | movement within |
| | | | | a vessel |
| | | | | containing a |
| | | | | dioramic scene |

### FIELD OF THE INVENTION

This invention relates generally to crystal ball or globe display systems, and more particularly to such a display system containing characters, sculptural landscapes, or scenes immersed in fluid (also commonly known as “snow globes”), and the field of video display devices with or without accompanying audio) activated by motion sensors and/or explicit user interface activities.

### BACKGROUND OF THE INVENTION AND DESCRIPTION OF THE PRIOR ART

Visual display systems contained within a crystal ball or globe (termed “snow globes” because a fluid-filled globe containing suspended particles would activate the particles to fall and appear like snow, when the globe was shaken) were first recorded in the late 1800s, in France. At the end of the 19th century Erwin Perzy, a producer of surgical instruments, invented the so-called Schneekugei (“snow globe”) and got the first patent for it in Vienna. He then built his first actual globe with the basilica of Mariazell (a small city in Austria) as a model within it. Because of the great request for his snow globes, Perzy, along with his brother Ludwig, opened a shop in Vienna, where the production continues until today as a family business.

Snow globes appeared at the Paris Universal Exposition of 1878, and by 1879, many more companies were producing snow globes and selling them throughout Europe. In 1889, a snow globe containing a model of the newly built Eiffel Tower was produced to commemorate the International Exposition in Paris. Snow globes became popular in England during the Victorian era and, in the early 1920s, crossed the Atlantic to the United States of America where they became a popular collectors item. Many of these snow globes were produced by Atlas Crystal Works in New Jersey, U.S., which also had factories in Germany.

In the United States, the first snow globe-related patent was granted in 1927 to Joseph Garaja of Pittsburgh, Pa. During the 1940s, snow globes were often used for advertising. In Europe, during the 1940s and 1950s, religious snow globes were common gifts for Catholic children. Snow globes have appeared in a number of film scenes, the most famous of which is the opening of the 1941 classic film Citizen Kane.

In the 1950s, snow globes, which previously were made of glass, became available in plastic. Currently, there are many different types of snow globes available. These globes are produced by a number of countries and range from the mass-produced versions made in Hong Kong and China, to finely crafted versions still produced in Austria. Snow globes feature diverse scenes, ranging from the typical vacation souvenirs to more eclectic collectibles featuring Christmas scenes, Disney characters, popular icons, animals, military figures, and historical vignettes. Snow globes have even been used for election campaigns. Snowglobe display systems typically include 3D figures or characters made of plastic or ceramic, mounted to a base within a transparent crystal ball or liquid-filled globe.

Furthermore, most snow globes also incorporate visually distinctive particles contained in the fluid which are capable of being stirred by shaking, twisting, and/or rotating the display in its entirety. Typically, such elements comprise glitter, confetti, or white, snowflake-like particles, and provide additional visual stimulation as the particles fall through the fluid by gravity. Once all of the particles are completely deposited on the base, due to the pull of gravity, the process can be repeated by lifting or shaking the globe to redisperse the particles throughout the fluid.

The use of globe assemblies is known in the prior art. U.S. Pat. No. 5,666,750 describes a decorative article with flake circulating properties. Another type of globe assembly is U.S. Pat. No. 5,816,884, which describes a music box having a water pump structure. U.S. Pat. No. 4,961,276 describes an ornamental crystal ball comprising a base, a ball mounted on the base and filled with water, a model disposed in the ball, a plurality of suspendable objects disposed in the ball, and a driving apparatus to flow the water and the suspendable objects. U.S. Pat. No. 4,641,445 describes a novelty display device that simulates snowfall.

Although crystal ball or globe display systems are extremely popular and fulfill particular objectives and requirements, all crystal ball display systems heretofore known suffer from a number of disadvantages:
(a) Prior displays incorporate static landscapes, dioramas, scenes, or unchanging imagery that remains static and permanent within the globe. None of the prior displays possess the capability of displaying imagery, video and/or optional audio that is activated and de-activated by human motion;
(b) Prior displays lack the capability to control playback, changing scenes, or fast-forwarding of displayed imagery, video and/or optional audio through human motion;
(c) Prior displays lack the capability to alternate, change, and/or replace the internal visual and audio content of the display system.
(d) Prior displays do not fully utilize the three-dimensional effect of viewing moving imagery through the lense created by a crystal ball or globe display system.
(e) The imagery and scenery of prior displays can be viewed and enjoyed only with an adequate light source (daylight or interior lighting), and cannot be viewed in the dark,
   The need remains for a crystal ball or globe display that includes certain improved features.

### SUMMARY

The present invention provides for a crystal ball pr fluid-filled globe with an electronic video display, such as an integrated organic light-emitting diode (OLED) or liquid crystal display (LCD). The invention permits activation and de-activation of digital video and/or audio, and motion of liquid and particles within the crystal ball or globe by the human motion of moving, shaking, twisting, or rotating the ball or globe. Optionally, the motion may trigger audio that accompanies the video playback, employing any number of audio reproduction means.

Disclosed is one embodiment of a crystal ball or globe display system. The system comprises a support base and an OLED video display mounted to and within the support base. The system further comprises a video controller with a video/audio storage means mounted to the OLED video display within the support base. The system further comprises a motion sensor integrated into the video controller, housed within the support base. The system further comprises a globe assembly mounted to the top of the support base, the globe assembly comprising a transparent enclosure, a transparent fluid sealed within a space defined by the transparent enclosure, and a transparent disc sealing the bottom of the transparent enclosure and providing for the viewing of the OLED video display through the transparent disc and the transparent fluid. The fluid may comprise a mixture of glycerin, glycol, distilled water, bleach, and/or bacteria-free water.

The system also comprises an OLED video display housed in the support base, whereby the OLED video display is driven and switched on by the video controller with a motion sensor, for motion sensitive activation of the globe assembly. The motion sensor and video controller is adapted to activate and de-activate digital video in the crystal ball or globe display system for entertainment and enjoyment.

Video imagery is viewed through the globe display system by mounting the globe assembly on top of the support base, and housing the OLED video display facing upward and within the support base of the assembly. The transparent disc at the base of the transparent enclosure encloses and seals the transparent enclosure. The OLED video display faces upward and abuts the transparent disc. This way, the fluid contained within the crystal ball or globe is maintained completely separate from the OLED video display and video controller, thereby enabling an OLED video display to be immediately adjacent to and viewed through the transparent disc and the transparent fluid-filled crystal ball or globe display.

The system also comprises a circuitry which is installed in the support base. The circuitry includes a video controller and motion sensor that generates an output signal in response to motion. The video controller responds to the signal from the motion sensor, in order to control the operations of the video storage and the video controller. The sensor signal has a digital format. Thus, the motion sensor comprises a micro-electromechanical systems (MEMS) accelerometer activated by changes in position along the x, y, and/or z axis of the globe display system. Furthermore, the system also comprises a power supply which supplies, through an external cord, five volts of DC power to a power conditioner and battery charger. The power supply takes 110-240 volts of AC power and converts it to 5 volts of DC power. The power supply is conditioned to power a rechargeable battery, which in turn powers the OLED video display and the video controller.

The circuitry further includes video and/or audio data storage through a micro-secure digital memory card (micro-SD card). Video data are read from the micro-SD card, processed by the video controller, and the video signal is delivered to the OLED video display. Furthermore, the video storage employs an encoding of the video data that allows for random access to video frames, which allows the stored video to be played in a non-linear sequence, such as backwards or fast-forward.

The circuitry also includes an optional audio speaker. The video controller decodes the audio data from the audio storage, and supplies the resulting audio signal to the audio speaker. The video controller is responsive to the signal from the motion sensor in order to control the operations of the audio storage means and the audio speaker.

The system also comprises a power supply, power conditioner, and battery charger which regulates charging current to the battery, and boosts the battery voltage to the level required by the video controller, OLED video display, and other circuitry. The power supply is designed to supply the required power to the motion sensor, the video controller, the video and/or audio storage, the OLED video display, and the audio speaker.

### Advantages

Technical advantages of the present invention include the crystal ball or fluid-filled globe display system integrating an OLED video display, which enhances the video viewing experience through magnification of the video imagery by the lease effect of the fluid-filled globe, and which is activated and de-activated by the human motion of shaking, tilting, twisting, or rotating the display system. Upon motion applied to the crystal ball or globe display system, digital video and/or audio is activated, viewed in an enhanced, magnified state by the lens effect of the crystal ball or fluid-filled globe, and attains a three-dimensional effect as a result of the lens. If motion is applied to the optional fluid-borne particles suspended within the fluid enclosed in the fluid-filled globe display system, those particles will also move and settle within the globe assembly, enhancing the virtual environment within the fluid-filled globe. Pre-recorded video and/or audio is seen and heard, and remains continuous until the crystal ball or globe display system has been motionless for a pre-determined time.

Movement viewed from within the crystal ball or globe assembly provides for enhancing the entertainment and enjoyment of the globe display system. Other features of the crystal ball or globe display system include use of the motion-sensing data for additional purposes. Demonstrated examples include the ability to view 360 degree panoramic scenes by tilting or rotating the crystal ball or globe display system during playback, and the use of rotational motion to view other portions of the stored video and audio content.

### DRAWINGS

### Figures

For a more complete understanding of the present invention, including its features and advantages, reference is made to the following detailed description of the invention in conjunction with the accompanying drawings of which:

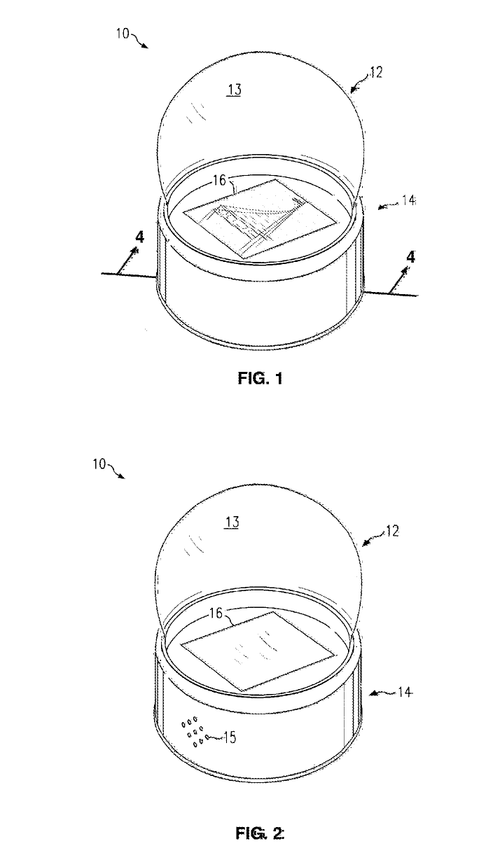

FIG. 1 illustrates a fluid-filled globe or crystal ball electronic display system according to a preferred embodiment of the present invention;

FIG. 2 shows a front perspective view of a fluid-filled globe or crystal ball electronic display system in accordance with the preferred embodiment of the present invention;

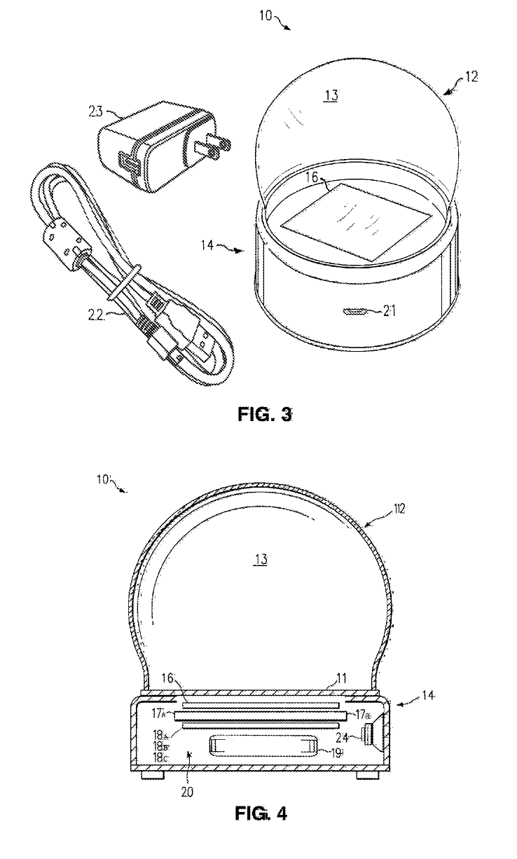

FIG. 3 shows a rear perspective view of a fluid-filled globe or crystal ball electronic display system in accordance with the preferred embodiment of the present invention;

FIG. 4 is a sectional view of a fluid-filled globe or crystal ball electronic display system in accordance with the preferred embodiment of the present invention;

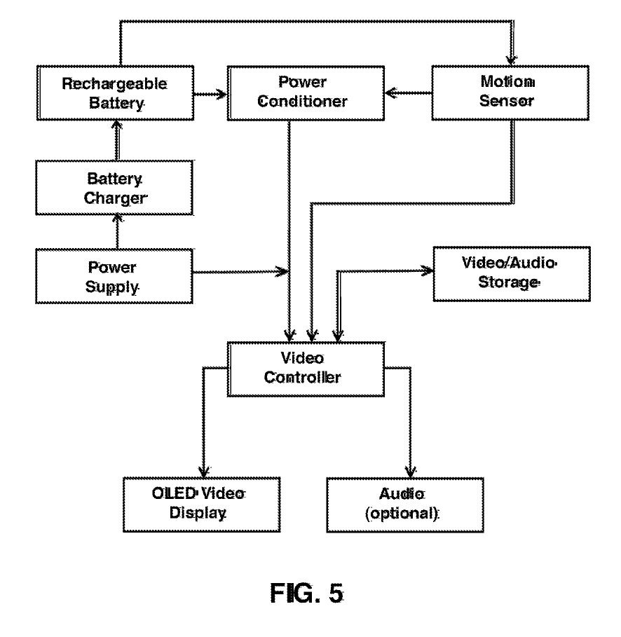

FIG. 5 is a block diagram of the circuitry of the fluid-filled globe or crystal ball electronic display system in FIG. 1;

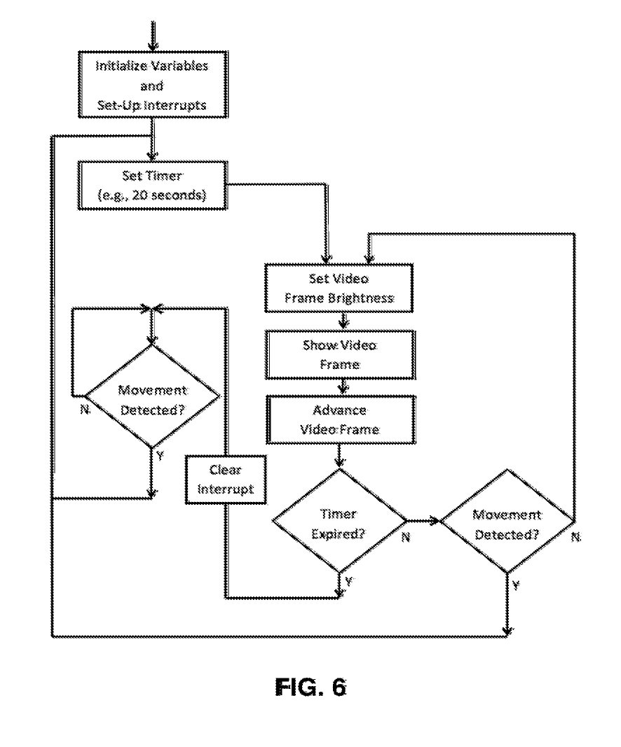

FIG. 6 is a video module software flowchart of the fluid-filled globe or crystal ball electronic display system in FIG. 1.

Corresponding numerals and symbols in the figures refer to corresponding parts in the detailed description unless otherwise indicated.

### DETAILED DESCRIPTION

### FIGS. 1, 2, 3, 4, 5, 6 of the Preferred Embodiment

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the invention.

To better understand the invention, reference is made to FIG. 1, which depicts an electronic fluid-filled globe or crystal ball display system 10 in accordance with the preferred embodiment of the present invention. The globe or crystal ball display system 10 comprises a support base assembly 14 and an OLED video display 16, which is mounted to the support base assembly 14. The OLED video display 16 may display video imagery of a figure, landscape, scene, or artwork, for example. The OLED video display 16 is activated through a motion sensor 18A (not shown) housed in the support base assembly 14.

The globe display system 10 includes a globe assembly 12 which is mounted to the support base assembly 14.

The globe assembly 12 comprises a substantially rounded and transparent enclosure 13 under which the OLED video display 16 is arranged for viewing from the outside of the transparent enclosure 13. The transparent enclosure 13, or globe, is adhered to a transparent disc 11 (not shown in this view) attached to the support base assembly 14. The globe assembly 12 is further defined as comprising a transparent fluid (e.g., water) sealed within the space defined by the transparent enclosure 13 or crystal ball in a manner providing for the viewing of the video display 16 through the fluid or crystal ball. Typically, the fluid-filled globe assembly 12 incorporates visually distinctive particles (not shown) contained in the fluid which are capable of being stirred by moving, shaking, twisting, and/or rotating the globe display system 10, and when activated in such a manner appear similar to snowflakes. Examples of such particles include glitter and confetti, which provide additional visual stimulation as the particles fall through the fluid in the transparent enclosure 13.

The globe display system 10 also comprises a video controller 17A (not shown) housed in the support base assembly 14. Other devices and configurations may also be employed, including an optional audio speaker system 24 (not shown) also controlled by the video controller 17A (not shown). The video controller 17A (not shown) is activated by a motion sensor 18A (not shown), upon motion, shaking, twisting, or rotating of the globe display system 10. Thus, the globe display system 10 produces video and/or audio, and a continuous flow of enclosed fluid in the fluid-filled transparent enclosure 13 or crystal ball when motion is applied to the globe assembly 13 by a person. In addition, if snowflake-like particles (not shown), for example, are also sealed with the fluid within the fluid-filled globe assembly 13, the motion causes the particles to continuously circulate from the applied motion, and for a brief time thereafter, for enjoyment and entertainment.

With reference to FIG. 2, a front perspective view of the globe display system 10 is shown in accordance with the preferred embodiment of the present invention. The motion sensor 18A (not shown), video controller 17A (not shown), and OLED video display 16 are housed in the support base assembly 14, and are all powered with a rechargeable battery 19 (not shown).

In one embodiment, motion of the electronic globe display system 10 activates the production of digital video on the OLED video display 16 viewed through the transparent enclosure 13, and/or audio which is heard from an internal audio speaker 24 (not shown) through small openings 15 in the support base assembly 14. Lack of motion of the globe display system 10 for a predetermined time de-activates any video or audio, as well as ceasing any movement of particles within the globe assembly 12. Lack of motion also generates a signal from the motion sensor 18A that suspends the supply of power to the OLED video display 16 and video controller 17A, putting the OLED video display 16 and video controller 17A into a quiescent, low-power state. As a result, energy is conserved and battery life is extended. The video and/or audio will also remain off until motion is once again applied to the globe display system 10. Such video and/or audio activated through motion of the globe display system 10 allows for amusement and edification.

With reference to FIG. 3, a rear perspective view of the globe display system 10 is shown in accordance with the preferred embodiment of the present invention. The motion sensor 18A (not shown), video controller 17A (not shown), and OLED video display 16 are housed in the support base assembly 14, and are all powered with a rechargeable battery 19 (not shown) housed in the support base assembly 14. The rechargeable battery 19 (not shown) uses an industry-standard micro-universal serial bus (USB) cord 22 to connect it to a power supply 23 that takes 110-240 volts of AC power and converts it to the 5 volt DC required by the circuitry means 20 (not shown) for charging. The micro-USB connector 21 connected to the circuitry 20 (not shown) which is housed in the support base assembly 14 is integrated in the side of the support base assembly 14, and connects the micro-USB cord 22 to the circuitry 20 (not shown).

With reference to FIG. 4, a simplified sectional view of the display system 10 is shown in accordance with the preferred embodiment of the present invention. The sectional view shows the transparent disk 11 adhered to the transparent enclosure 13, which is attached to the support base assembly 14.

With reference to FIG. 4, within the sectional view is shown the circuitry 20 housed in the support base assembly 14 as shown in FIG. 3.

The circuitry 20 comprises the OLED video display 16, the video controller 17A, the video and/or audio storage 17B (not shown, but integrated in the video controller 17A), the motion sensor 18A, the power conditioning means 18B, the rechargeable battery 19, and an optional audio producing means 24. The OLED video display 16 is connected to and activated by the video controller 17A. The video controller 17A is connected to and activated by the motion sensor 18A and power conditioner 18B (which is integrated within the same circuit board as the motion sensor 18A). The section view also shows the rechargeable battery 19 which is connected to the motion sensor 18A and power conditioner 18B.

### Operation—FIGS. 1, 2, 3, 4, 5, 6

As previously discussed, once motion is applied to the electronic globe display system 10 through movement, shaking, twisting, or rotating, the motion sensor 18A is activated through the generation of an output signal. The output signal then communicates with the circuitry 20 resulting in activation of the video controller 17A to initiate and provide content from the video and/or audio storage 17B (not shown) to the video display 16 and/or audio speaker 24 (not shown and the circulation of fluid and dispersal of particles, if it is a fluid-filled globe.

Upon activation, the motion sensor 18A, which is connected directly to the rechargeable battery 19, communicates with the video controller 17A. Thus, the video controller 17A is responsive to the signal from the motion sensor 18A, and controls the operations of the video storage 17B (not shown), the video display 16, and the audio speaker 24. The video storage 17B comprises a micro-Secure digital card (micro-SD card) for storing video and audio data therein. Furthermore, the video controller 17A decodes the video data from the video storage means 17B (not shown), and supplies the resulting video signal to the OLED video display 16. Concurrently, if there is an audio signal, the video controller 17A decodes the audio signal from the video storage 17B, and supplies an amplified audio signal to the audio speaker 24. The pre-recorded video, for example, is then displayed on the video display 16 and heard from the audio speaker 24 for enjoyment and relaxation.

With reference to FIG. 5, in battery-operated mode, voltage from the single 3.7V lithium polymer LiPo rechargeable battery 19 is boosted to 5V to power the remaining circuitry. In turn, the boosted 5V DC powers the video controller 17A, and the OLED video display 16. Alongside, the motion sensor 18A is powered directly from the rechargeable battery 19.

When the motion sensor 18A detects movement, it generates an interrupt that enables the power conditioner 18B, which boots the micro-processor in the video controller 17A, which plays back video on the OLED video display 16 and optional audio through the audio speaker 24 until no motion is sensed for a programmed number of seconds. During playback, the motion sensor 18A is polled to see if motion is persisting. Further, the motion sensor 18A data is available to change video playback speeds, allow for scrolling of panoramic video and imagery, and to determine when to perform other user interface functions, like skipping to another video or audio segment. When the globe display system 10 has been motionless for a pre-determined time that indicates that the user has abandoned it, the video controller 17A clears the motion sensor 18A interrupt, which signals the power conditioner 18B to stop producing 5V, the OLED video display 16 is blanked, and the video controller 17A shuts down, (and audio, if any, ceases to play, as well).

This shutdown is actually preceded by a ramping down of the brightness of the OLED video display 16 and the volume of the audio, if any, so that the shutdown is less jarring for the user of the device.

Everything in the circuitry 20 except the motion sensor 18A then idles, with only the motion sensor 18A active to sense the next motion of the globe display system 10. This mode of operation, where everything in the circuitry 28 is shut down, except the motion sensor 18A, requires an exceedingly small amount of power, allowing the globe display system 10 to run for eight weeks in this stand-by mode.

When the life of the rechargeable battery 19 is exhausted, the rechargeable battery 19 can no longer drive the power conditioner 18B and the video controller 17A will cease to function, even though the motion sensor 18A will be indicating that it should. At this point, the user needs to plug the globe display system 10 into a conventional household AC wall socket with the micro-USB cord 22 and power supply 23 for recharging. In other embodiments, the globe display system 10 might have disposable batteries that would need to be replaced at this juncture. In the present embodiment, the power supply 23 is plugged into 110-240V AC mains electricity (at 50-60 Hz), and it produces 5V DC. This 5V power is supplied to the battery charger 18C (integrated within the same circuit board as the motion sensor 18A and power conditioner 18B), which is designed to safely charge the rechargeable battery 19. This 5V power is also routed directly to the video controller 17A, so that the globe display system 10 can operate, albeit tethered, while charging is underway.

While this invention has been described with a reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

For example, the circuitry 20 currently requires that video and audio be pre-loaded into the video and/or audio storage 17B. The inventors anticipate developments which would allow end users to replace and/or augment the original video and audio data. Another example substitutes a miniature video projector for the OLED video display 16. This projector would not be limited to displaying video on the planar area at the bottom of the transparent enclosure 13, but could actually project video material onto surfaces, planar and otherwise, inside the globe assembly 12.

### With Reference to FIG. 6

FIG. 6 outlines the software controlling the globe display system 10 through a flowchart representation. In the current embodiment, this software flow is coded in a language that is provided in the software development toolkit that was supplied with the video controller 17A.

During initialization, variables are initialized; interrupts are set up, and a timer is set to a given time-out value. The code then proceeds to check to see if that time-out value has been reached, and time has expired.

If the timer has not expired, and movement is detected, the timer is reset to its initial value, the OLED video display 16 continues to display video, the audio (if present) continues to play out of the audio speaker 24 at normal volume, and flow of action continues. Video frames are displayed on the OLED video display 16, and the sequence of video frames is advanced. After each frame is displayed, the timer is checked.

If the timer has not expired and movement is not detected, frames will continue to show on the OLED video display 16 and advance video frames and playback audio until the timer expires.

The above scenario describes the situation where a user has begun playing the video and/or audio in the globe display system 10 by moving or shaking it. If, after initially activating the globe display system 10 through such motion, the user then continues to shake it before the pre-determined time-out period occurs, the globe display system 10 will continue to display video and play audio, as long as such motion and shaking continues.

As the software approaches the expiration time, the software slowly darkens the OLED video display 16 and mutes the audio emitting from the audio speaker 24. Once the expiration time has been reached, the software then loops, checking for movement that exceeds a threshold value. If movement over a threshold value is detected during this loop, the timer is set to the given time-out value, and operation of the OLED video display 16 brightens and resumes playing.

The paragraph above describes the situation where a user has begun playing the video and/or audio in the globe display system 10 by moving or shaking it. If, after activating the globe display system 10 through such motion, the user then sets it down on a table where it remains motionless for 20 seconds, for example, the OLED video display 16 will darken, the volume of audio from the audio speaker 24 will decrease, and if no further motion is detected, the globe display system will shift into a stand-by low power mode.

Operation is slightly different when the device is, and is not being charged by a power supply 23.

When the globe display system 10 is being charged by a power supply 23, the motion sensor 18A, which raises an interrupt upon lack of movement, will clear that interrupt (the motion sensor 18A signal to turn off the globe display system 10 will have no effect), and the globe display system 10 will still run, but will go dark. This is because the globe display system 10 is receiving power from the power supply 23, and not the rechargeable battery 19.

When the device is not being charged by the power supply 23, when the motion sensor's 18A interrupt is cleared, power stops flowing to the video controller 17A and OLED video display 16. The video controller 17A has turned itself off to conserve energy. Subsequently, when the motion sensor 18A detects motion, it raises an interrupt, which turns on the power conditioner 18B, which reboots the video controller 17A, and the software flow of FIG. 6 resumes.

### CONCLUSIONS, RAMIFICATIONS, AND SCOPE

Accordingly, the reader will see that the electronic display systems described in the various embodiments provide users with a compelling and highly entertaining interactive experience. The novelty of the motion-based interaction, in combination with the recognizable physical form of the apparatus, gives users and immediate recognition about how to interact with it, while delighting users with the video and/or audio content. Long battery life and robust construction make our electronic display system very low-maintenance and reliable. Furthermore, the electronic display system has the additional advantages in that:

Its electronic display screen is much more dynamic than other devices of this sort. Historically, the snow globe form has contained plastic or glass figurines and depictions. The invention herein, with its full-motion video display, solves this problem.

The electronic display of our device is highly interactive, with controllable playback, multiple scenes, different depictions of time (vs. the single-moment depicted by traditional snow globes), the ability to view the included video scenes from different angles, and (in most cases) lack supporting audio.

The electronic display system can have content that is more personalized and current than that of its historical precedents, simply by populating the video/audio storage immediately prior to sale.

The glowing video display permits the apparatus to be used in lighting conditions where the contents of the traditional snow globe form would be difficult to see.

The translucent or transparent form atop the electronic display screen enhances the viewing experience, magnifying the material being played and further enhancing the experience.

In short, the presented invention is a radical improvement over prior snow globes in several fundamental ways. Although the description above contains many specificities, these should not be construed as limiting the scope of the of the embodiments but as merely providing illustrations of some of several embodiments. For example, although much of the language about the preferred embodiment has revolved about the fluid-filled variety of the apparatus, our first implementation, with a solid plastic sphere, was also extremely compelling. Other shapes have proven amusing, as had other forms of interactivity, like having tilt of the device control a view into higher-resolution imagery (e.g., we've allowed people to look around the landscape captured by the Mars rover).

Thus the scope of the embodiments should be determined by the appended claims and their legal equivalents, rather than by the given examples.

What is claimed is:

1. An electronic display system comprising:
a support base;
a display mounted to said support base;
a transparent or translucent form mounted to said support base, said transparent or translucent form surrounding said display, said transparent or translucent form mounted in a manner providing for the viewing of said display through said transparent or translucent form;
a video producing means housed in said support base, said video producing means driven by a sensing means which activates said video producing means;
an audio producing means housed in said support base, said audio producing means driven by a sensing means which activates said audio producing means; and
a circuitry means installed within said support base to power and control said video producing means with said sensing means.

2. The electronic display system according to claim 1 wherein said video producing means comprises a light-emitting diode (LED) array or liquid crystal display (LCD) panel

3. The electronic display system according to claim 1 wherein said audio producing means comprises internal audio transducer;

4. The electronic display system according to claim 1 wherein said sensing means is further defined as comprising one or more selected from the group consisting of accelerometers, capacitive sensors, rate gyros, magnetometers, tilt sensors, mercury switches, reed switches, manual switches, and photo cells.

5. The electronic display system according to claim 1 wherein said transparent or translucent form is spherical or ovoid.

6. The electronic display system according to claim 1 wherein sensing means comprises a MEMS accelerometer.

7. An electronic display system comprising:
a support base;
a display mounted to said support base;
a transparent or translucent fluid-filled form mounted to said support base,
said transparent or translucent fluid-filled form surrounding said display, said transparent or translucent fluid-filled form mounted in a manner providing for the viewing of said display through said transparent or translucent fluid-filled form;
a video producing means housed in said support base, said video producing means driven by a sensing means which activates said video producing means;
an audio producing means housed in said support base, said audio producing means driven by a sensing means which activates said audio producing means; and
a circuitry means installed within said support base to power and control said video producing means with said sensing means.

8. The electronic display system according to claim 7 wherein said video producing means comprises a light-emitting diode (LED) array or liquid crystal display (LCD) panel

9. The electronic display system according to claim 7 wherein said audio producing means comprises internal audio transducer;

10. The electronic display system according to claim 7 wherein said sensing means is further defined as comprising one or more selected from the group consisting of accelerometers, capacitive sensors, rate gyros, magnetometers, tilt sensors, mercury switches, reed switches, manual switches, and photo cells.

11. The electronic display system according to claim 7 wherein said transparent or translucent fluid-filled form is spherical or ovoid.

12. The electronic display system according to claim 7 wherein said transparent or translucent fluid-filled form includes water-borne particulates.

13. The electronic display system according to claim 7 wherein sensing means comprises a MEMS accelerometer.
